(19) United States
(12) Patent Application Publication
(10) Pub. No.: US 2004/0110890 A1
(43) Pub. Date: Jun. 10, 2004

(54) Polyester compositions for appearance parts

(76) Inventor: Claire Brissot, Thoiry (FR)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/648,671

(22) Filed: Aug. 26, 2003

Related U.S. Application Data
(60) Provisional application No. 60/406,473, filed on Aug. 28, 2002.

(51) Int. Cl. C08L 67/02

(52) U.S. Cl. 524/502; 525/165

(57) ABSTRACT

Polyester compositions which contain a copolymer of ethylene, an acrylate ester, and a fibrous filler having a relatively small diameter are particularly suitable for parts whose surface appearance is important, such as appliance panels and automobile body panels. The compositions have good toughness and an otherwise excellent balance of other physical properties.

### CROSS REFERENCE TO RELATED APPLICATIONS

This application claims the benefit of U.S. Provisional Application No. 60/406,473 filed Aug. 28, 2002.

### FIELD THE INVENTION

Polyester compositions which contain a copolymer of ethylene and an acrylate ester, and a fibrous filler having a relatively small diameter, are particularly suitable for parts whose surface appearance is important, such as appliance panels and automobile body panels, and have a good balance of other desired properties.

### FIELD OF THE INVENTION

Thermoplastics are used in a myriad of applications. These applications range from those where the appearance of the thermoplastic part is unimportant to those where the appearance is critical. In consumer items, the appearance of the items is often important and in some instances critical to the acceptance of the article by the potential customer. For example, the appearance of appliances, (power) tools, motor vehicles, home electronic equipment, toys, garden and agricultural machinery and vehicles, and boats, is often important to the potential customer's decision to buy, including the perceived quality of the item. Various types of thermoplastics are used for appearance parts, but where the part also performs some structural function and/or must withstand heat and physical abuse, so-called “engineering polymers” are often used. Among these are polyesters which often have a good balance of physical properties, low water absorption, and thermal resistance. However sometimes one or more of these properties needs to be enhanced by the use of various agents such as fillers and/or toughening agents. However, the addition of these types of materials often results in poorer appearance of the finished part, and therefore obtaining a good balance of appearance and other properties is often a challenge. Thus, new compositions with good combinations of such properties are constantly being sought.

The toughening of polyesters is described in U.S. Pat. No. 4,753,980 in which certain polymers containing repeat units from two or three different monomers are blended with polyesters. The results of Examples 2 and 12 (together with results from U.S. Pat. No. 4,172,980) illustrate that in unfilled compositions adding ethylene/n-butyl acrylate copolymer has little or no effect on the toughness (as measured by Notched Izod) of poly(ethylene terephthalate) or poly(butylene terephthalate).

The toughening of polyesters using various types of polymers dispersed in the polyester as toughening agents is known, see for instance U.S. Pat. No. 4,172,859. None of the ethylene copolymers described herein are described, and all ethylene copolymers in this patent have at least two other types of repeat units present in the polymer.

U.S. Pat. No. 5,817,723 describes certain copolymers as toughening agents for various types of thermoplastics. Only examples of toughening polyoxymethylene are described.

The use of certain “needlelike” fillers of specified dimensions in polymer compositions having good surface appearance is known, see for instance U.S. Pat. No. 5,965,655. The use of these fillers with the tougheners described herein is not disclosed.

### SUMMARY OF THE INVENTION

This invention concerns, a composition, comprising:

(a) about 1.0 to about 40 percent by weight of a copolymer (EA) consisting essentially of repeat units derived from ethylene, and a compound of the formula H₂C═CHCO₂R¹ (I), wherein R¹ is an alkyl group containing 1 to 8 carbon atoms, and said ethylene-derived repeat units are about 65 to about 95 weight percent of said copolymer, and (I)-derived repeat units are about 5 to about 35 weight percent of said copolymer;

(b) about 35 to about 90 percent by weight of a semicrystalline polyester; and

(c) about 5 to about 30 percent by weight of short fibers having a number average diameter of about 6 μm or less;

wherein the parts by weight are based on the total amount of (a), (b) and (c) present.

Also disclosed are shaped articles of the above compositions, including automotive body panels, appliance panels, (power) tool housings, and the like.

### DETAILS OF THE INVENTION

Herein certain terms are used, and some of them are:

By a “semicrystalline polyester” (SCPE) is meant a polyester, which may be a homopolymer or copolymer, which has a heat of fusion of at least about 5 J/g, more preferably at least about 10 J/g, and preferably a preferably melting point of at least about 80° C., more preferably at least about 150° C. (for measurement see below). The SCPE may be an isotropic polyester or a liquid crystalline polyester, and is preferably an isotropic polyester. The “TOT Test” for whether a polymer is isotropic or liquid crystalline is described in U.S. Pat. No. 4,118,372, which is hereby included by reference.

By “short fibers” (SF) are meant organic or inorganic fibers having an aspect ratio (ratio of length to diameter) of about 200 or less. These fibers are sometimes also described as “needle-like” or “whiskers”.

By “a” or “an” herein, such as an SCPE, EA or SF is meant one or more.

By “comprising” herein is meant the named items (materials), and any other additional materials or compositions may be present.

A semicrystalline polyester is part of the present composition. Preferred semicrystalline polyesters are poly(alkylene terephthalates) such a poly(ethylene terephthalate)(PET), poly(1,3-propylene terephthalate)(PPT), and poly(1,4-butylene terephthalate)(PBT), poly[1,4-bis(hydroxymethyl)cyclohexane terephthalate](PCT) and their copolymers containing small amounts (<30 mole percent of the diol and/or diacid components, as appropriate) of other monomers, such as diethylene glycol, isophthalic acid, and 1,4-bis(hydroxymethyl)cyclohexane. PET and PBT and their copolymers are especially preferred. Another useful copolymer is derived from terephthalic acid, ethylene glycol and a relatively low molecular weight poly(ethylene oxide), and is not limited to <30 mole percent poly(ethylene oxide). By derived from herein means derived from that compound or any other chemically equivalent compound in a polymerization reaction. Other useful semicrystalline polyesters are “polyarylates” such as a polymer from bisphenol-A and terephthalic acid or a mixture of terephthalic and isophthalic acids.

Surprisingly the EA is believed to act as a toughener for the present composition which is often needed to make the composition useful for parts such as automotive body panels, particularly when SF is present. In addition the EA surprisingly does not deleteriously affect the appearance of polyester containing parts made with the composition. Many tougheners for polyesters, such as many of those described in U.S. Pat. Nos. 4,172,859 and 5,817,723 cause the surface of such parts, especially large parts, to have waviness or undulations, thereby detracting from their appearance. Parts made with compositions containing the EA of the present invention generally speaking have low waviness or undulations in the surface, and also have glossy surfaces which have a pleasing appearance and may be painted to give, for instance so-called “Class A” surfaces, particularly useful for automotive body panels.

The EA is about 5 to about 35% by weight, preferably about 3 to about 25% by weight, of the total of the EA, SCPE and SF present in the composition. In a preferred EA, R¹ is alkyl containing 2 to 4 carbon atoms, more preferably R¹ is ethyl or n-butyl.

The composition also contains SF, which in combination with the SCPE and EA gives a composition which has the needed stiffness, thermal sag resistance, surface qualities and toughness desired in many appearance parts. The composition contains about 5 to about 30 percent by weight of the SF, based on the total amount of EA, SCPE and SF present, preferably about 10 to about 25 percent by weight of SF. The SF has an number average diameter of about 6.0 μm or less, more preferably about 0.1 μm to about 6.0 μm, more preferably about 1.0 μm to about 5.5 μm, as determined by optical or electron microscopy at 700×. The actual value of the number average diameter and aspect ratio is calculated using appropriate measurements and calculations of the microscopy images, usually using computer processing. Preferably these SFs have average aspect ratios of about 3 to about 50, more preferably about 5 to about 20. Useful SFs (of the correct particle size) include wollastonite and glass, and wollastonite is preferred. These SFs do not detract significantly from the appearance of parts made containing the SFs. Oftentimes as the aspect ratio of the SF increases, the heat sag (see below) decreases and stiffness increases.

For other preferred SF dimensions, the number average maximum dimension (length) is about 20 μm or less, more preferably about 15 μm or less, very preferably about 10 μm or less. A preferred minimum average longest dimension is about 0.10 μm or more, more preferably about 0.5 μm or more. Preferably less than 10% of the SF particles have a longest dimension of about 100 μm or more, more preferably less than 5%. Any of these ratios or dimensions may be combined with any other ratios or dimensions of the reinforcing agent, as appropriate. Surface smoothness is often improved is the particle size of the reinforcing agent is towards the small end of the range.

Useful specific SFs include wollastonite, aramid fibers, fibrils or fibrids, carbon fibers, glass fibers, potassium titanate whiskers, boron nitride whiskers, aluminum borate whiskers, magnesium sulfate whiskers and calcium carbonate whiskers. Preferred SFs are wollastonite, potassium titanate whiskers, boron nitride whiskers and aluminum borate whiskers, and an especially preferred SF is wollastonite. All of these specific SFs should have the appropriate dimensions as outlined above. These SFs may be coated with adhesion promoters or other materials which are commonly used to coat fibers used in thermoplastics.

Preferably the composition is about 55 to about 85 weight percent of the SCPE, based on the total amount of SCPE, EA and SF present in the composition.

Other materials normally found in thermoplastic compositions may also be present in these compositions, although if the appearance of parts made from them is important, they should preferably not detract from such appearance, nor preferably should they detract from desirable physical properties. Such materials include antioxidants, pigments, other fillers, lubricants, plasticizers, nucleating agents, and flame retardants. Particularly useful additives include lubricants such perfluoropolymers, epoxy resins such as Epon® 1009 (available from Shell Chemical Co.) in small amounts such as about 0.1 to about 1.0 weight percent (of the entire composition), preferably about 0.3 to about 0.5 weight percent. In PET containing compositions plasticizers and/or nucleating agents in conventional amounts are preferred additives.

The present compositions may be prepared by conventional techniques, for instance melt mixing the ingredients in typical melt mixing equipment such as single or twin screw extruders, see for instance U.S. Pat. Nos. 5,817,723, 4,172,859, 4,753,980 and European Patent Application 639,613, all of which are hereby included by reference, and the Examples herein.

Shaped parts may be molded from these compositions by any conventional melt forming technique, such as injection molding, extrusion, foaming, and blow molding. Other thermoplastic forming techniques such as rotational molding and thermoforming may also be used.

Although the present compositions may be used for making shaped parts in general, they are particularly useful for so-called appearance parts, that is parts whose (surface) appearance is an important attribute of the part quality, particularly in having a smooth, glossy appearing surface. These parts may also be painted to enhance their appearance. The underlying surface is important in obtaining a pleasing painted surface.

One particular type of part that can be made with these compositions are (exterior) automotive body panels, particularly vertical body panels such as fenders, quarter panel, and door panels. Other automotive “parts” included herein as body panels include spoilers and mirror housings. Typically these are painted, but they also may be colored with pigments mixed into the composition instead. In either case a so-called Class A finish may be obtained with finish systems typically used for automotive vehicles. Another important property for such panels is low heat sag, that is the ability not to sag when heated (in the heat sag test described herein a value of “0” is best, with low absolute values desirable). This is particularly important when the panel is to be painted on line as it will be subjected to high temperature thermal excursion. It is preferred that the (absolute) heat sag value be about 2.0 mm or less, particularly at 200° C.

Another type of part is interior or exterior panels or chassises for large appliances such a refrigerators, washing machines, clothes dryers, and dishwashers. These panels or chassises are appearance parts in that they are visible to the consumer and therefore it is desirable that they have a pleasing appearance. In this instance the parts may be colored by addition of pigment(s) to the polymeric composition or they may be painted.

Housings, cabinets or panels for smaller items such as power tools, small appliances such electric mixers, steam irons, toasters, and microwave ovens, and electronic devices such as computer housings, computer monitor housings, television set cabinets, radio cabinets, computer printers housings, VCR housings, and DVD player housings, may also be made from these compositions. In this instance also the parts may be colored by addition of pigment(s) to the polymeric composition, or they may be painted.

Furniture such as “plastic” chairs, tables, cabinets, may also be made from these compositions. These may be made with a “natural” color, pigments may be added to supply color, or they may be painted.

Garden and agricultural equipment and vehicles may also contain appearance parts of the present composition, painted or unpainted, for examples parts, including panels, for lawn and garden tractors, and door panels for tractors.

Because these compositions yield shaped parts with smooth surfaces that also tend to have very little waviness, they may be used as “substrates” for reflectors. For example the surfaces of the reflectors may be metal coated by a variety of methods such as vapor phase deposition, electroplating, metal sputtering, or by using a metallic paint. The resulting parts (if the metal deposition is done correctly) will have a smooth surface and be highly reflective. Thus these parts would be useful as reflectors for lighting such as automotive headlights, automotive tail lights, and decorative lighting, and as mirrors. When used as lighting reflectors the parts must be useful at sufficiently high temperatures that the heat from a light source does not cause damage (for example melting or distortion) to the reflector.

Toys made from these compositions where the glossy surfaces will be attractive to children. The shaped parts for the toys may be colored by the use of pigments in the compositions, thereby avoiding the use of paints which maybe toxic or otherwise harmful to children. The toughness of these compositions particularly lends them to use in toys that receive rough use.

Herein melting points and heats of fusion are determined by ASTM D3418-82, at a heating rate of 20° C./min. The peak of the melting endotherm is taken as the melting point. The heat of fusion is taken as the area under the melting endotherm. All of these are remeasured on the second heat, that is the sample is heated at 20° C./min until the melting point and/or glass transition point, whichever is higher, is exceeded, and then the sample is cooled at 20° C./min to 30° C. Measurements are then taken on a second heat, also done at 20° C./min.

The test fixture for heat sag is capable of holding the test samples in a fixed position for the entire test. The fixture is made of aluminum, which exhibits a low coefficient of linear thermal expansion. The sample is clamped (bolted) to the fixture so that 112 mm of the length of the sample overhangs the edge of the fixture. The distance (Ao) from lower outer edge of the horizontal sample to the bottom of the fixture is measured to 0.1 mm. The samples are R60 tensile bars, 168 mm long and 4 mm thick. Two bars per sample are used. The fixture (and bars) are placed in an oven at the desired test temperature and remain there for 30 min, after which the fixture is removed from the oven and the bars allowed to cool. If necessary the clamp is retightened and the distance between the base and the edge of the bar is measured again (Af) when the system is at room temperature. The sag value is calculated as Ao-Af (usually in mm). Often test series carried out on different dates cannot be accurately compared, so comparative heat sag values are preferably obtained when the samples are tested together.

Instrumented impact was measured using the Ceast® Dart Tester (Ceast S.p.a.), which is a dart impact tester. The dart had a 3 mm diameter.

For the optical surface characterization of painted surfaces the “Wave Scan” (Byk-Gardner GmbH, D-82538 Geretsried, Germany) was used. The Wave Scan is an orange peel meter, simulates the visual evaluation of surface smoothness. The operation principle is based on the modulation of the reflected light of a small laser diode by surface structures. The laser light illuminates the surface under 60° C. and the reflected light is detected at the same but opposite angle. During the measurement the instrument is moved over a scan length of approximately 10 cm, where every 0.08 mm a data point is recorded. The measured data are separated into long wave (LW) (>0.6 mm) and short wave (SW) (<0.6 mm) signals by mathematical filtering. Values for long term and short term waviness are obtained by the variance of the filtered data.

Melt indices were measured by ASTM D1238 at a 2190 g load and 190° C.

In the Examples PTS is penterythritol tetrastearate.

In the Examples certain ingredients are used, and they are:

Crystar® 1906—A PET copolymer, inherent viscosity 0.65, containing 12 mole percent copolymerized poly(ethylene oxide) available from E. I DuPont de Nemours & Co., Inc, Wilmington, Del. 19898, USA

Crystar® 3934—PET homopolymer, IV=0.67, available from E. I. DuPont de Nemours & Co., Inc., Wilmington, Del. 19898 USA

DOI—distinctness of image measured by Dorigon method

Hostamont® NAV 101—sodium montanate available from Clariant Corp. D-65840 Sulzbach am Taunns, Germany

Irganox® 1010—antioxidant available from Ciba Specialty Chemicals, Tarrytown, N.Y. 10591, USA.

Nyad®M 1250—3 μm particle size wollastonite available from Nyco Minerals, Willsboro, N.Y., USA.

Nyglos® 4—4 μm diameter wollastonite fibers with no sizing available from Nyco Minerals, Calgary, AB, Canada.

Nyglos® 5—average 5 μm length wollastonite fibers with no sizing available from Nyco Minerals, Calgary, AB, Canada.

Plasthall® 809—polyethylene glycol 400 di-2-ethylhexanoate.

Polymer C—ethylene/n-butyl acrylate/glycidyl methacrylate (67/28/5 wt. %) copolymer.

Polymer D—a copolymer of ethylene (73 wt. %) and n-butyl acrylate (27 wt %) have a melt index of 4 g/10 min.

Surlyn® 8920—ethylene/methacrylic acid (85/15 wt. %) copolymer, neutralized with sodium, melt index 0.9 g/10 min, available from E. I. DuPont de Nemours & Co., Inc, Wilmington, Del. 19898, USA

Uniplex® 810—a plasticizer which is poly(ethylene glycol) dilaurate with an average molecular weight of 946 available from Unitex Chemical Corp., Greensboro, N.C. 27406, USA

### EXAMPLES 1-5

The compositions were compounded on a 40 mm Berstorff twin screw extruder. Irganox® 1010, the PTS, trisodium phosphate, and Polymers C and D were first preblended and then added to the first barrel of the extruder. The Plasthall® 809 was injected in the front barrel, and the Crystar® polymers were added to the rear of the extruder, and Nyglos® 4 was side fed. The extruder was run at 300 rpm, the torque was 80, the throughput about 80 kg/h, and the melt temperature was 280° C. The compositions were molded on an Engel 1250 injection molding machine, with a melt temperature of 280° C., a mold temperature of 110° C., and a mold pressure of 80 MPa. Compositions and test results are given in Table 1.

TABLE 1

| | | | Example | | | | |
|---|---|---|---|---|---|---|---|
| | Method | Unit | 1 | 2 | 3 | 4 | 5 |
| Crystar ® 3934 | | | 25.42 | 23.42 | 23.42 | 23.42 | 21.62 |
| Crystar ® 1906 | | | 43 | 40 | 40 | 40 | 36.8 |
| Polymer C | | | | | | | 5 |
| Polymer D | | | 10 | 10 | 10 | 10 | 10 |
| Trisodium phosphate | | | 0.7 | 0.7 | 0.7 | 0.7 | 0.7 |
| Plasthall ® 809 | | | 4.44 | 4.44 | 4.44 | 4.44 | 4.44 |
| PTS | | | 0.9 | 0.9 | 0.9 | 0.9 | 0.9 |
| Irganox ® 1010 | | | 0.54 | 0.54 | 0.54 | 0.54 | 0.54 |
| Nyglos ® 4 | | | 15 | 15 | 10 | 5 | 10 |
| Nyad ® M400 or M1250 | | | | 5 | 10 | 15 | 10 |
| Sum | | | 100.00 | 100.00 | 100.00 | 100.00 | 100.00 |
| Tensile Testing | ISO R60/NE | | | | | | |
| E Modulus | 527-1/2 | MPa | 2587.6 | 2639.7 | 2415.6 | 2100.6 | 1399.2 |
| Strain @ yield | 527-1/2 | % | 3 | 2.8 | 2.9 | 3.1 | 6.2 |
| Strain @ break | 527-1/2 | % | 10.3 | 6.9 | 8.1 | 12.5 | 15.2 |
| Stress @ break | 527-1/2 | MPa | 38.6 | 38.3 | 36 | 33.1 | 28.5 |
| Impact | | | | | | | |
| Charpy unotched | 179/1eU | KJ/m² | 34.16 | 32.24 | 33.92 | 31.78 | 37.95 |
| Charpy notch | 179/1eA | KJ/m² | | | | | |
| Heat sag | | | | | | | |
| 180° C., 30 min | | mm | −2 | −1.75 | −3.5 | −4 | −4.9 |
| 200° C., 30 min | | mm | −1.85 | −3.25 | −4 | −5.4 | −5.75 |
| Flex E-Modulus | iso 178 | | | | | | |
| Flex Strength | | MPa | 16.1 | | | | |
| E-Modulus | | MPa | 2578 | | | | |

### EXAMPLES 6-8

The compositions were compounded on a 40 mm Berstorff twin screw extruder. Irganox® 1010, the PTS, trisodium phosphate, and Polymer D were first preblended and then added to the first barrel of the extruder. The Plasthall® 809 was injected in the front barrel, and the Crystar® polymers were added to the rear of the extruder, and Nyglos® 4 was side fed. The extruder was run at 400 rpm, the torque was 35-40, the throughput about 70-100 kg/h, and the melt temperature was 285° C. The compositions were molded on an Engel 1250 injection molding machine, with a melt temperature of 260° C., a mold temperature of 110° C., and a mold pressure of 80 MPa. Compositions and test results are given in Table 2.

TABLE 2

| | | | Example | | |
|---|---|---|---|---|---|
| | Method | Unit | 6 | 7 | 8 |
| Crystar ® 3934 | | | 25.96 | 27.86 | 29.86 |
| Crystar ® 1906 | | | 43.9 | 47 | 50 |
| Plasthall 809 | | | 3 | 3 | 3 |
| Polymer D | | | 10 | 5 | |
| TSP | | | 0.7 | 0.7 | 0.7 |
| PTS | | | 0.9 | 0.9 | 0.9 |
| Irganox ® 1010 | | | 0.54 | 0.54 | 0.54 |
| Nyglos ® 4 | | | 15 | 15 | 15 |
| Sum | | | 100.00 | 100.00 | 100.00 |
| Tensile Testing | ISO Tensile | | | | |
| | R60/NE | | | | |
| E Modulus | 527-1/2 | MPa | 2540.5 | 3039.4 | 3163.7 |
| Strain @ Yield | 527-1/2 | MPa | 4.1 | 1.3 | 0.8 |
| Strain at break | 527-1/2 | % | 14.1 | 14 | 15.2 |
| Stress @ Yield | 527-1/2 | MPa | 37.7 | 31.7 | 24.8 |
| Impact | | | | | |
| Charpy | 179/1eU | KJ/m² | 40.37 | 40.33 | 49.11 |
| unotched | | | | | |
| Charpy notch | 179/1eA | KJ/m² | 2.37 | 2.08 | 2.30 |
| Heat sag | | | | | |
| 200° C., 30 min | | Mm | −2.40 | −1.85 | −2.20 |

### EXAMPLES 9-13

The compositions were compounded on a 40 mm Berstorff twin screw extruder. Irganox® 1010, the PTS, Hostamont® NAV 101, and Polymer D were first preblended and then added to the first barrel of the extruder. The Plasthall® 809 was injected in the front barrel, and the Crystar® polymers were added to the rear of the extruder, and Nyglos® 5 was side fed. The extruder was run at 400 rpm, the torque was 35-40, the throughput about 70-100 kg/h, and the melt temperature was 285° C. The compositions were molded on an Engel 1250 injection molding machine, with a melt temperature of 260° C., a mold temperature of 110° C., and a mold pressure of 80 MPa. Compositions and test results are given in Table 3. For reference purposes, a painted metal surface had a long wave value of 4.0, a short wave value of 7.5, and a DOI of 96.7.

TABLE 3

| | | | Example | | | | |
|---|---|---|---|---|---|---|---|
| | Method | Unit | 9 | 10 | 11 | 12 | 13 |
| Crystar ® 3934 | | | 81.56 | 76.01 | 31.53 | 29.31 | 25.11 |
| Crystar ® 1906 | | | | | 50.03 | 46.7 | 39.8 |
| Nyglos ® 5 | | | 15 | 15 | 15 | 15 | 15 |
| Polymer D | | | 0 | 5.55 | 0 | 5.55 | 16.65 |
| Plasthall ® 809 | | | 1.5 | 1.5 | 1.5 | 1.5 | 1.5 |
| Hostamont ® NAV 101 | | | 0.5 | 0.5 | 0.5 | 0.5 | 0.5 |
| PTS | | | 0.9 | 0.9 | 0.9 | 0.9 | 0.9 |
| Irganox ® 1010 | | | 0.54 | 0.54 | 0.54 | 0.54 | 0.54 |
| Sum | | | 100.00 | 100.00 | 100.00 | 100.00 | 100.00 |
| Flex Modulus | ISO 178 | MPa | 4700.00 | 4029.00 | 3863.00 | 3321.00 | 2895.00 |
| Flex strength | ISO 178 | MPa | 28.10 | 24.00 | 23.10 | 20.30 | 17.90 |
| Tensile Testing | | | | | | | |
| E Modulus | 527-1/2 | MPa | 5251.9 | 4505.1 | 2711.4 | 3463.9 | 2985.1 |
| Strain @ Yield | 527-1/2 | % | 2.6 | 2.3 | 5.5 | 3 | 2.8 |
| Strain @ break | 527-1/2 | % | 2.5 | 6.7 | 12 | 11.5 | 10.2 |
| Stress @ Yield | 527-1/2 | MPa | 80.2 | 59.9 | 58.1 | 52.8 | 42.2 |
| Charpy unnotched | ISO 179/1eU | KJ/m² | 26.22 | 36.01 | 18.36 | 43.32 | 32.63 |
| Heat Sag, 210° C., 30 min | | mm | −3.25 | −3.5 | −5.25 | −4.75 | −4.5 |
| CEAST Impact at 23° C. | | | | | | | |
| Force max | ISO 6603-2 | N | 1109.25 | 1248.75 | 852.75 | 1165.5 | 1017 |
| Energy at force max | ISO 6603-2 | J | 1.7 | 1.9 | 0.8 | 2.377 | 1.98 |
| Total energy of break | ISO 6603-2 | J | 3.4 | 3.6 | 2.4 | 3.64 | 4.51 |
| Painted Surface | | | | | | | |
| Long Wave | | | 4.0 | 7.1 | 9.8 | 5.6 | 9.1 |
| Short Wave | | | 7.5 | 7.5 | 9.3 | 26.2 | 34.0 |
| DOI (Dorigon) | | | 96.7 | 95.7 | 95.5 | 91.0 | 86.3 |

What is claimed is:

1. A composition, comprising:
(a) about 1.0 to about 40 percent by weight of a copolymer consisting essentially of repeat units derived from ethylene, and a compound of the formula H₂C═CHCO₂R¹ (I), wherein R¹ is an alkyl group containing 1 to 8 carbon atoms, and said ethylene-derived repeat units are about 65 to about 95 weight percent of said copolymer, and said (I)-derived repeat units are about 5 to about 35 weight percent of said copolymer;
(b) about 35 to about 90 percent by weight of a semicrystalline polyester; and
(c) about 5 to about 30 percent by weight of short fibers having a number average diameter of about 6 μm or less;
wherein the parts by weight are based on the total amount of (a), (b) and (c) present.

2. The composition as recited in claim 1 wherein R¹ is ethyl or n-butyl.

3. The composition as recited in claim 1 wherein said copolymer is about 3 to about 25 percent by weight, said semicrystalline polyester is about 55 to about 80 percent by weight, and said short fibers are about 10 to about 25 percent by weight, of the total of (a), (b) and (c) present in said composition.

4. The composition as recited in claim 1 wherein said short fiber has a number average length of about 20 μm or less.

5. The composition as recited in claim 1 wherein said aspect ratio is about 3 to about 50, and said short fiber has a number average length of about 0.5 μm to about 10 μm, and said short fiber is about 10 to about 25 percent by weight of the total amount of (a), (b) and (c) present.

6. The composition as recited in claim 1 wherein said short fibers are wollastonite.

7. The composition as recited in claim 1 or 5 wherein said semicrystalline polyester is a poly(alkylene terephthalate).

8. The composition as recited in claim 7 wherein said poly(alkylene terephthalate) is poly(ethylene terephthalate) or poly(1,4-butylene terephthalate).

9. An appearance part comprising the composition of claim 1, 2 or 3.

10. The appearance part as recited in claim 9 which is painted.

11. An automotive body panel comprising the composition of claim 1, 2 or 3.

12. The automotive body panel as recited in claim 11 which is painted.

13. The automotive body panel as recited in claim 12, wherein paint is applied on line.

14. An appliance, power tool, electronic device, furniture, reflector, or toy comprising the composition of claim 1, 2, or 3.

15. The appliance, power tool, electronic device, furniture, reflector, or toy, wherein said composition is painted.
